(19) United States
(12) Patent Application Publication
(10) Pub. No.: US 2017/0152169 A1
(43) Pub. Date: Jun. 1, 2017

(54) Method and apparatus for use of corrosive gases at elevated temperatures

(71) Applicants: Shek-Chung Gau, Framingham, MA (US); Sho-Fen Gau, Framingham, MA (US)

(72) Inventors: Shek-Chung Gau, Framingham, MA (US); Sho-Fen Gau, Framingham, MA (US)

(21) Appl. No.: 14/757,181

(22) Filed: Dec. 1, 2015

(51) Int. Cl. C03B 35/16

(52) U.S. Cl. CPC C03B 35/16

(57) ABSTRACT

Treatment of films by laser annealing; particularly for silicon films in magnetron sputtering and continuous plasma-enhanced chemical vapor deposition.

### BACKGROUND OF THE INVENTION

Silicon and other semiconductor devices are in widespread use but do not always perform well certain applications, such as those used for display.

Accordingly it is an objective of the invention to improve the performance of silicon and other semiconductor devices.

A related objective is to achieve improved performance for high volume and low cost operation.

### BRIEF DESCRIPTION OF THE DRAWINGS

Other aspects and objectives of the invention will become apparent after considering several illustrative embodiments taken in conjunction with the drawings in which:

FIG. 1 shows a distribution of laser beams in accordance with the invention for annealing a silicon film;

FIG. 2 is schematic diagram of an in-line system of magnetron sputtering with annealing laser beams incorporated in accordance with the invention;

FIG. 2A is an enlargement of FIG. 2;

FIG. 3 is a schematic diagram of a magnetron sputtering system with annealing laser beams incorporated in accordance with the invention.

FIG. 4 is a schematic diagram of an in-line Plasma Enhanced Chemical Vapor Deposition (PECVD) system incorporating annealing laser beams of the invention

FIG. 4A is an enlargement of FIG. 4;

FIG. 5 is a schematic diagram of a single PECVD system with annealing laser beams incorporated

### SUMMARY OF THE INVENTION

The invention provides apparatus in which at least one crystal can be formed on a film by laser scanning. The film desirably is less than 10 millimeters in thickness and deposited on a substrate by a gas such as silane.

The crystal can be produced by laser scanning from below the substrate using a plurality of laser beams.

The film desirably is in a deposition chamber, which can be of Chemical Vapor Deposition (CVD) type. The deposition chamber can be Plasma Enhanced (PE).

The deposition chamber desirably contains hydrogen and the film subjected to magnetic sputtering.

In a method of the for producing a crystal grain, the steps include (1) providing a film and (2) laser scanning the film to produce at least one crystal grain thereon.

The method can employ a film is less than 10 millimeters in thickness and deposited on a substrate by a gas such as silane.

In the method a crystal grain can be produced by laser scanning from below a substrate, and the scanning can be by a plurality of laser beams.

According to the method the film desirably is in a deposition chamber, which can be of chemical vapor deposition type and be plasma enhanced.

In the method the deposition chamber can hydrogen and the film be produced by magnetic sputtering on a substrate that is conductive, with the substrate being of a hard, brittle, non-crystalline material, more or less transparent and produced by fusion, usually containing mutually dissolved silica and silicates that also contain soda and lime.

### DETAILED DESCRIPTION

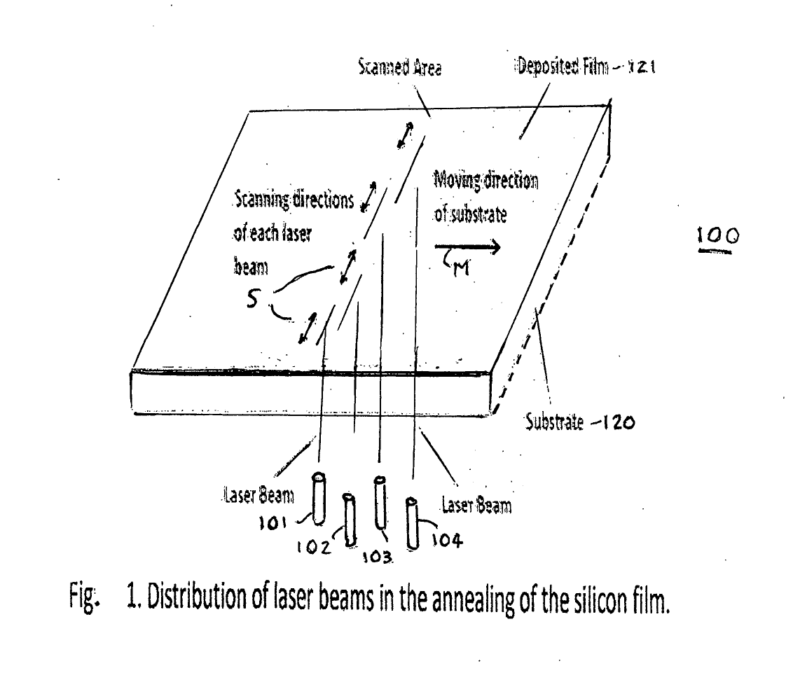

With reference to FIG. 1, a distribution 100 of lasers 101-104 is shown for beams for the annealing of a silicon film 121 in accordance with the invention on a substrate 120, which is conductive glass coated with a tin oxide (Sn02), indium tin oxide (ITO) or zinc oxide (ZnO).

The lasers 101-104 can be of any suitable type including the double frequency neodymium-doped yttrium orthovanadate (Nd: YV04) diode-pumped solid-state laser (wavelength 532 nm), the excimer laser, diode laser, copper vapor laser, argon ion laser, etc. Depending on the size of the substrate 120, multiple laser beams, up to 50 beams, can be used to cover the surface of the substrate 120, which is moving in the direction indicated by the arrow M. The scanning directions of the lasers, perpendicular to the moving directions of the substrate 120, are indicated by the arrow S.

To ensure the total coverage of the deposited film, each laser beam is allowed to overlap with the neighboring laser scanning. The incident laser beams irradiate through the substrate 120 and reach the deposited film 121 for the annealing process of the silicon film. The energy density of the beam is adjusted so that each laser pulse melts the amorphous silicon (a-Si) film within the irradiated zone and large crystals are formed in the cooling process.

These large Si crystals act as “seeded crystals” for the next layer of crystal formation when a fresh new film is deposited and the laser annealing is applied. The annealing with the laser beams is processed during the formation of the silicon films. Annealing with the laser beams is in the presence of hydrogen for sputtering. The annealing is in the presence of hydrogen and silane for Plasma-Enhanced Chemical Vapor Deposition (PECVD) which is used to deposit thin films from a gas state to a solid state on a substrate. Chemical reactions occur after creation of a plasma of the reacting gases created by a Radio Frequency (RF-AC) or Direct Current (DC) discharge between two electrodes providing a space which is filled with the reacting gases.

Each crystal is a solid body having a characteristic internal structure and enclosed by symmetrically arranged plane surfaces, intersecting at definite and characteristic angles.

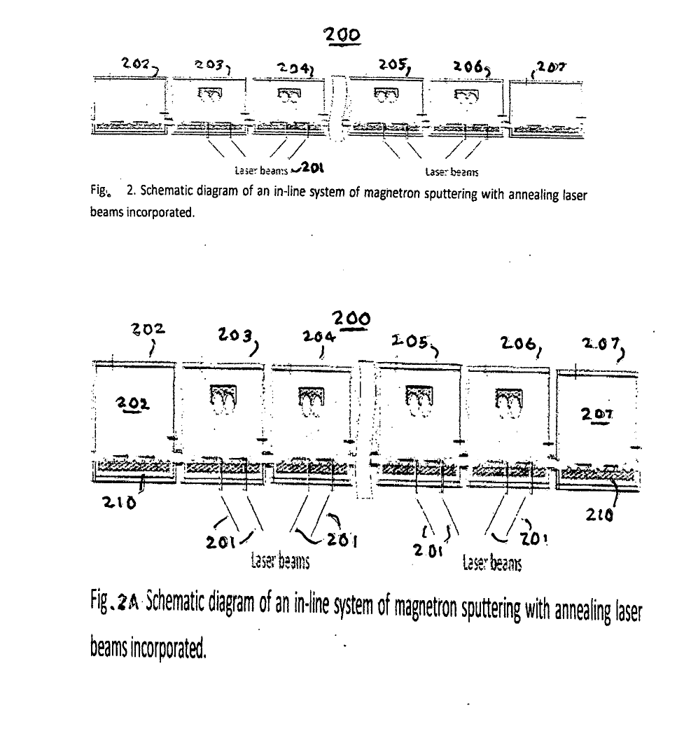

With reference to FIGS. 2 and 2A there is shown an in-line system 200 of magnetron sputtering with annealing laser beams 201 incorporated for laser annealing of silicon film in a continuous magnetron sputtering process. The in-line system 200 is composed of many single magnetron sputtering chambers 203-206. The beginning chamber(s) 202 is (are) used as entrance chambers and the ending chamber(s) 207 is (are) for exit of the substrate panels 210.

The number of deposition chambers 202-207 can be varied depending on the throughput required. By incorporating the laser beams into the system 200, the Si film is annealed as soon as thick enough film is formed. This will simplify the annealing process and save the production time.

The numbers, the positions, the shapes and the power density of the laser beams 201 can be adjusted from chamber to chamber. To obtained better quality of crystals, the type of laser can be varied from chamber to chamber.

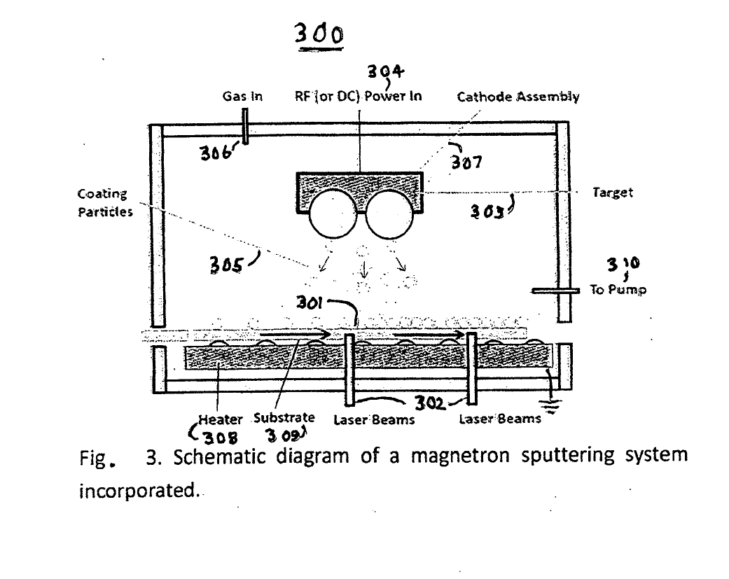

With reference to FIG. 3, the laser annealing of silicon film in a single sputtering system 300 is described as follows: A magnetron sputtering system 301 with annealing laser beams 302 incorporates either circular silicon targets or planner silicon targets 303. Either radio frequency (RF) or direct current (DC) power 304 can be used. The power 304 allows the production of coating particles 305 at the target 303 of the cathode assembly 307.

A mixture of hydrogen and argon, or pure argon, can be used as the input gas 306 and exited by a pump 310. The hydrogen/argon percentage can vary from 1% to 99%, but other inert gases can also be used. The substrate 309 can be heated from 500 to 4500 degrees Centigrade by a heater 308, and the deposition of silicon film 301 can be in a horizontal system as shown, or vertical system.

In the case of a vertical system, laser beams will irradiate horizontally into the vertical substrate and reach the deposited Si film at a right angle.

The numbers, the positions, the shapes and power density of the laser beams 302 in the system can be adjusted according to the deposited films.

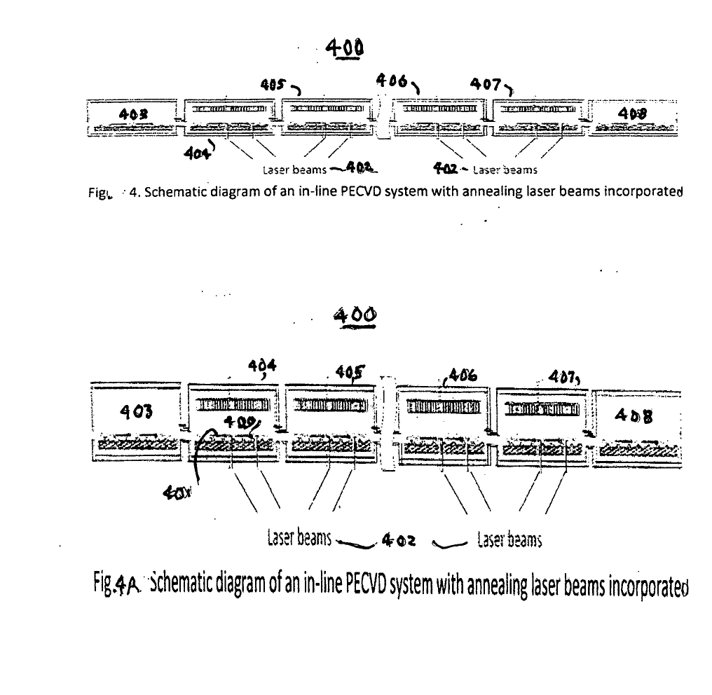

With reference to FIG. 4, there is shown in-line Plasma Enhanced Chemical Vapor Deposition (PECVD) system 400 for laser annealing of silicon film 401 by laser beams 402. The in-line system 400 is composed of many single PECVO chambers 403-408. The beginning chamber(s) 403 is (are) used as entrance chambers and the ending chamber(s) 408 is (are) for exit of the substrate panels 409.

The numbers of the deposition chambers 403-408 can be varied depending on the throughput required. By incorporating the laser beams 402 into the system 400, the Si film 401 is annealed as soon as thick enough film is formed. This will simplify the process and save the production time. The numbers, the positions, the shapes and the power density of the laser beams 402 can be adjusted from chamber to chamber. To obtained better quality of crystals, the type of laser can be varied from chamber to chamber.

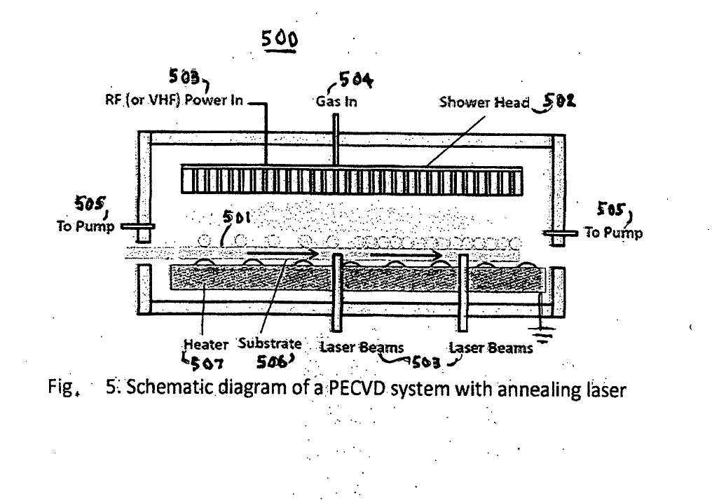

With reference to FIG. 5. The laser annealing of silicon film 501 in a single PECVO system 500 is described as follows: The system 500 incorporates a shower head 502 and either Radio Frequency (RF) or Direct Current (DC) power 303 can be used.

Mixture with hydrogen can be used as the input gas 504 and exited by pumps 505. The substrate 506 can be heated from 500° to 450° Centigrade by a heater 507, and the deposition of silicon film 501 can be in a horizontal system as shown, or vertical system.

The reactive gases are mixtures of hydrogen and silane for the i-layer, with the hydrogen/silane percentage varying from 1% to 99%. Appropriate dopant gases can be incorporated for the p- and n-layers.

Depending on the hydrogen content of the gas phase and the power of the RF or Very High Frequency (VHF), the film 301 that is deposited may be amorphous or microcrystalline Si. The power of the laser beams 508 needs to be adjusted to get proper annealing.

The hydrogen/silane mixtures are evenly distributed through a well-designed shower head to flow into the discharge zone. In the application to solar cells, large crystals of p-layer can be made as “seeded crystals” for the i-layer crystal formation. In the case of a vertical system, laser beams will irradiate horizontally into the vertical substrate and reach the deposited Si film at a right angle.

The numbers, the positions, the shapes and the power density of the laser beams 508 in the system can be adjusted according to the deposited films.

While the present invention has been illustrated and described with respect to particular structures and method of manufacture, it is apparent that various changes and modifications may be made therein within the scope of the appended claims.

What is claimed:

1. Apparatus comprising
a film and
at least one crystal formed on said film by laser scanning.

2. Apparatus as defined in claim 1 wherein said film is less than 10 millimeters in thickness and deposited on a substrate by silane.

3. Apparatus as defined in claim 2 wherein said crystal is produced by laser scanning from below said substrate.

4. Apparatus as defined in claim 3 wherein said laser scanning is produced by a plurality of laser beams.

5. Apparatus as defined in claim 3 wherein said film is in a deposition chamber.

6. Apparatus as defined in claim 3 wherein said film is in a chemical vapor deposition chamber.

7. Apparatus as defined in claim 5 wherein said deposition chamber is plasma enhanced.

8. Apparatus as defined in claim 5 wherein said deposition chamber contains hydrogen.

9. Apparatus as defined in claim 3 wherein said film is in a deposition chamber with magnetic sputtering.

10. A method of producing a crystal grain comprising
(1) providing a film and
(2) laser scanning said film to produce at least one crystal grain thereon.

11. The method as defined in claim 10 wherein said film is less than 10 millimeters in thickness and deposited on a substrate by silane.

12. The method as defined in claim 10 wherein said crystal grain is produced by laser scanning from below said substrate.

13. The method as defined in claim 10 wherein said laser scanning is produced by a plurality of laser beams.

14. The method as defined in claim 10 wherein said film is in a deposition chamber.

15. The method as defined in claim 14 wherein said film is in a chemical vapor deposition chamber.

16. The method as defined in claim 14 wherein said deposition chamber is plasma enhanced.

17. The method as defined in claim 14 wherein said deposition chamber contains hydrogen

18. The method as defined in claim 14 wherein said film is in a deposition chamber with magnetic sputtering.

19. The method as defined in claim 11 wherein said substrate is conductive.

20. The method as defined in claim 11 wherein said substrate is of a hard, brittle, non-crystalline material, more or less transparent and produced by fusion, usually containing mutually dissolved silica and silicates that also contain soda and lime.
